(19) United States
(12) Patent Application Publication
(10) Pub. No.: US 2013/0202350 A1
(43) Pub. Date: Aug. 8, 2013

(54) ASSIST HANDLE CLIP FOR HEADLINER MODULE OF AUTOMOBILE

(71) Applicant: Daehan Solution Co., Ltd., Incheon (KR)

(72) Inventors: Choong Ho KWON, Seoul (KR); Hoe-Hyun KWON, Seoul (KR)

(73) Assignee: DAEHAN SOLUTION CO., LTD, Incheon (KR)

(21) Appl. No.: 13/761,259

(22) Filed: Feb. 7, 2013

(30) Foreign Application Priority Data
Feb. 7, 2012 (KR) 10-2012-0012078
Dec. 1, 2012 (KR) 10-2012-0138617

(51) Int. Cl. F16B 2/20

(52) U.S. Cl. CPC F16B 2/20
USPC 403/335

(57) ABSTRACT

An assistant handle clip for a module headliner of an automobile, which includes a base and a hook integrally bent from the base. The hook includes: support arms bent at opposite sides of the base in the inward opposite directions; flanges, each of which extends toward opposite sides of an upper end of each support arm and is bent downward; two pairs of retaining arms bent at opposite sides of the flanges in the outward opposite directions; retaining parts bent at lower ends of the retaining arms in the inward opposite directions; retaining steps bent downward at lower ends of the retaining parts; and at least one noiseproof protrusion protruding from opposite faces of the flanges in the inward opposite directions.

### FIELD OF INVENTION

The present invention relates to an assistant handle clip for a module headliner of an automobile and, more particularly, to an assistant handle clip for a module headliner of an automobile, which is configured to provide a simple manufacturing process and a low manufacturing cost, and to inhibit the generation of noise when in use after being mounted on the automobile.

### BACKGROUND

In general, the interior of an automobile is provided with a plurality of assistant handles at opposite upper ends thereof so as to enable seat occupants to hold the assistant handles. The assistant handles are located in the interior of the automobile, i.e. at the lower side of a headliner, and are fixedly connected to a body panel of the automobile.

To this end, conventionally, the headliner was attached to the interior of the automobile during automobile manufacturing, and then the assistant handles were fastened to the body panel by screws one by one. This method was not suitable for automobile manufacturing, since during manufacturing an assembly line needs to be simple and efficient. As such, a modular assembly method has recently been employed and used in which sub-assemblies have been prepared by previously attaching the assistant handles to the headliner at a subcontractor, supplied to an automobile company, and attached to the body panel at the automobile company during automobile manufacturing.

As shown in FIGS. 1 and 2, a conventional assistant handle clip (hereinafter simply referred to as “conventional clip”), which is used for this modular assembly method and is disclosed in Patent Document 1 of Related Art Documents, is formed by bending a metal sheet cut in a quadrangular shape, and includes a base 31 that is assembled between a body panel 10 and a headliner 20 of an automobile at a base end thereof, and a hook 33 that is integrally bent from the base 31 at a leading end thereof and is fitted into a coupling hole 11 of the body panel 10. Further, the base 31 is provided with a fastening hole 31 a in the middle thereof for attaching an assistant handle 40, for example, by screwing. The hook 33 includes inner walls 34 bent at opposite sides of the base 31 in inward opposite directions so as to be inclined upward, outer walls 36 bent at upper ends of the inner walls 34 in outward opposite directions so as to be inclined downward, engagement parts 38 bent at lower ends of the outer walls 36 so as to be inclined downward, and support steps 38a bent downward at tips of the engagement parts 38. When pushed into the coupling hole 11 of the body panel 10, the hook 33 is coupled to the coupling hole 11 of the body panel 10 while the engagement parts 38 become narrower. Then, the engagement parts 38 become wider in the outward opposite directions due to their elastic force, and thus are fixed to the body panel 10.

The conventional clip used for the modular assembly method is generally manufactured by a sequential press process of performing a plurality of forming and cutting processes on a quadrangular metal sheet and gradually finishing the metal sheet in a desired shape.

Thus, as the shape of the conventional clip is complicated, and as the number of cutout parts increases, the total number of press processes required to manufacture the conventional clip is increased. As such, a manufacturing cost is increased due to an increase in the number of necessary dies and manufacturing time. To reduce the manufacturing cost, there is a need to change a structure of the conventional clip into a structure in which the conventional clip has a simple shape and a small number of cutout parts.

However, the hook 33 of the conventional clip is configured so that the inner walls 34 are bent at the opposite sides of the base 31 in the inward opposite directions so as to be inclined upward, and so that the outer walls 36 are bent at the upper ends of the inner walls 34 in the outward opposite directions so as to be inclined downward, and thus the conventional clip has a complicated structure. As shown in FIG. 6(a), the conventional clip has openings 34a formed at opposite sides of the inner walls 34 and openings 36a formed in the middles of the outer walls 36. For this reason, the conventional clip typically requires 18 to 25 processes. The number of processes ranging from 18 to 25 is a significant number, and thus the conventional clip has a problem in that a large number of processes are required to manufacture it.

Further, the hook 33 of the conventional clip is configured so that each inner wall 34 and each outer wall 36 overlap in whole in the vertical direction in such a manner that the inner walls 34 are bent at the opposite sides of the base 31 in the inward opposite directions so as to be inclined upward, and then the outer walls 36 are bent at the upper ends of the inner walls 34 in the outward opposite directions so as to be inclined downward, i.e. that the inner walls 34 extend from the base 31 in the upward direction and then the outer walls 36 extend from the upper ends of the inner walls 34 to the vicinity of the base 31 in the downward direction. As such, the required metal sheet requires a longer length than that for the structure in which the inner and outer walls partially overlap in the vertical direction. Thus, the metal sheet required to manufacture the conventional clip has a problem that its size is increased.

In addition, when a passenger holds the assistant handle fixed to the body panel of the automobile by the conventional clip, force is applied downward. The upper ends 34b of the inner walls 34 slide in surface contact with each other by means of the applied force and accelerating and decelerating forces generated by the traveling of the automobile, and thus generate problematic noise.

### PATENT DOCUMENT

[Patent Document 1] Korean Patent No. 10-0552014 (entitled “Assistant Handle Clip for Module Headliner of Automobile)

### SUMMARY

Accordingly, the present invention has been made in view of the above problems occurring in the related art, and is directed to providing an assistant handle clip for a module headliner of an automobile, in which the number of manufacturing processes is reduced, and a required size of a metal sheet is reduced, thereby allowing a reduction in manufacturing cost.

Another object of the present invention is directed to reduce the amount of noise that may be generated from an assistant handle clip when the assistant handle is in use.

According to an aspect of the present invention, there is provided an assistant handle clip for a module headliner of an automobile, which includes a base (110) that is assembled between a body panel (10) and the headliner (20) of the automobile at a base end thereof, and a hook (120) that is integrally bent from the base (110) at a leading end thereof and is fitted into a coupling hole (11) of the body panel (10), wherein the hook (120) includes: support arms (121a) bent at opposite sides of the base (110) in inward opposite directions so as to be inclined upward; flanges (121b), each of which extends toward opposite sides of an upper end of each support arm (121a) and is bent downward; two pairs of retaining arms (122) bent at opposite sides of the flanges (121b) in outward opposite directions so as to be inclined downward; retaining parts (123) bent at lower ends of the retaining arms (122) in the inward opposite directions so as to be inclined downward; retaining steps (124) bent downward at lower ends of the retaining parts (123) and hooked on a circumferential surface (11a) of the coupling hole (11) of the body panel (10); and at least one noiseproof protrusion (125) protruding from opposite faces of the flanges (121b) in the inward opposite directions so as to suppress noises caused by mutual contact between the flanges (121b).

According to the present invention as described above, a simple structure is applied to a hook in such a manner that the flanges are formed at the upper ends of the support arms and that the retaining arms extend from the flanges. Thereby, the number of processes required to manufacture the assistant handle clip for a module headliner for an automobile, and a required size of a metal sheet are reduced, so that it is possible to reduce manufacturing costs.

Further, the assistant handle clip includes at least one noiseproof protrusion protruding from the opposite faces of the flanges in the inward opposite directions so as to reduce a contact area between the flanges. Thereby, it is possible to suppress noise caused by surface contact between the flanges.

### BRIEF DESCRIPTION OF THE DRAWINGS

FIG. 1 is a perspective view showing a conventional assistant handle clip.

FIG. 2 is a cross-sectional view showing an appearance in which the conventional assistant handle clip is assembled.

FIG. 3 is a perspective view showing an assistant handle clip for a module headliner of an automobile according to an embodiment of the present invention.

FIG. 4 is a perspective view showing a modification of the assistant handle clip for a module headliner of an automobile according to the embodiment of the present invention.

FIG. 5 is a cross-sectional view showing an appearance in which the assistant handle clip for a module headliner of an automobile according to the embodiment of the present invention is assembled.

FIG. 6(a) is a schematic development view showing the conventional assistant handle clip.

FIG. 6(b) is a schematic development view showing the assistant handle clip for a module headliner of an automobile according to the embodiment of the present invention is assembled.

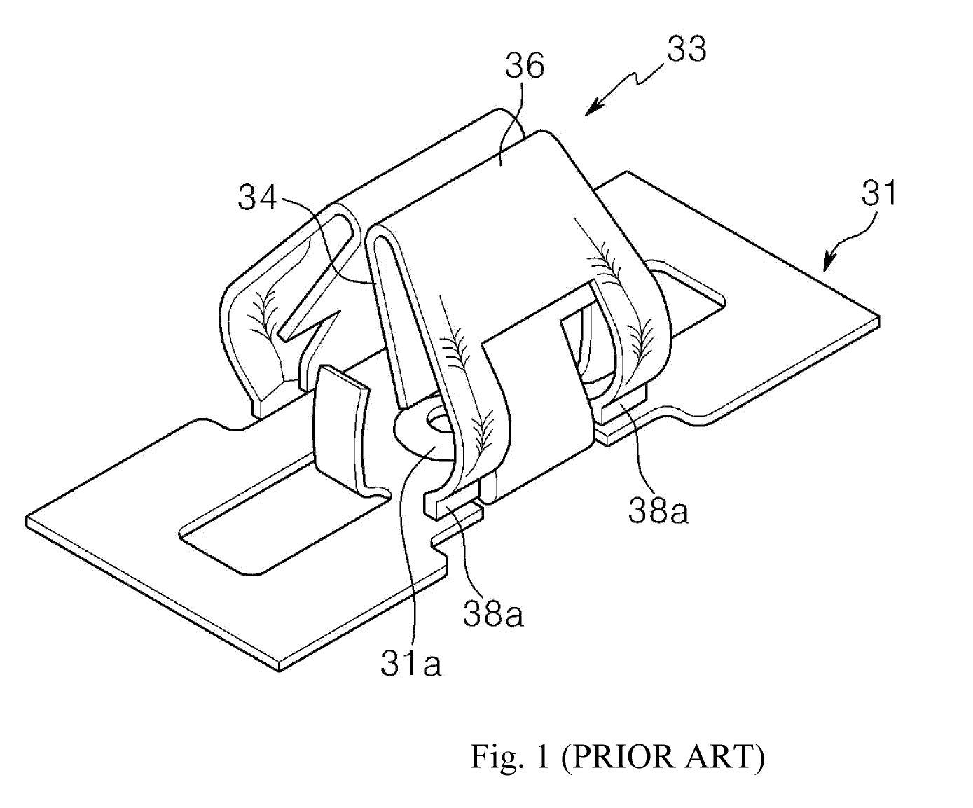

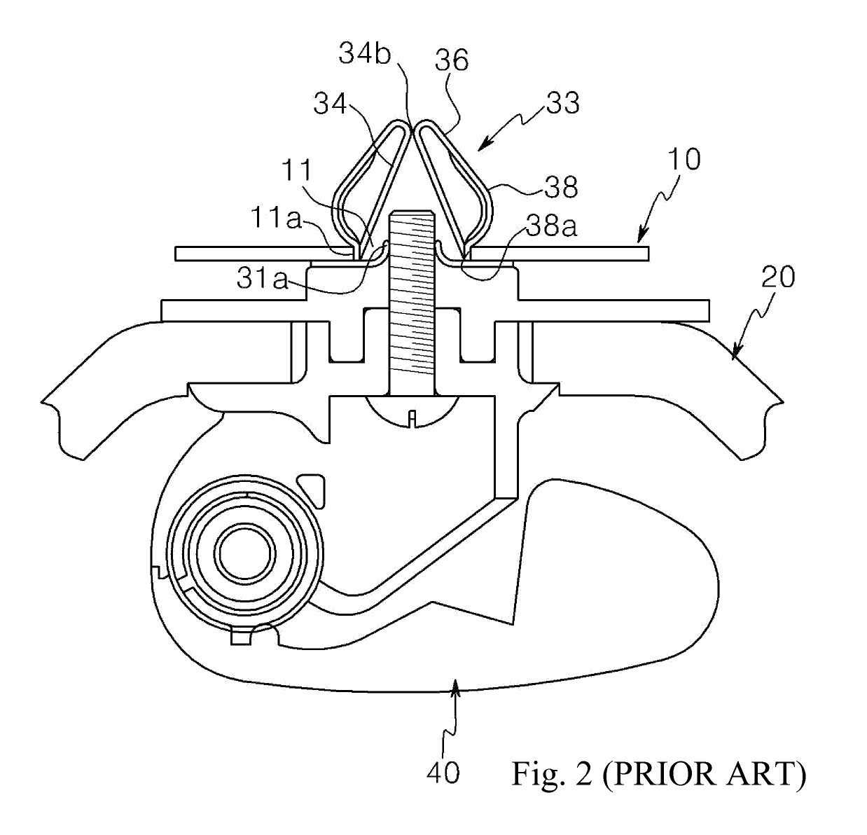

### DETAILED DESCRIPTION OF VARIOUS EMBODIMENTS OF THE DISCLOSURE

Hereinafter, exemplary embodiments of the present invention will be described in detail with reference to the accompanying drawings. The terms or words used in the specification and claims are not to be interpreted by their typical or dictionary means but meanings and concepts should be construed in conformity with the technical idea of the invention, based on the principle that the inventor can properly define the concepts of the terms so as to explain the invention in the best manner.

Accordingly, the embodiments described in the specification and the configurations shown in the drawings are only one illustrative example of the invention, not to represent the technical idea of the invention. Therefore, it should be understood that a variety of equivalents and modifications can be made at the time of filing the invention.

An assistant handle clip (hereinafter simply referred to as “inventive clip”) for a module headliner of an automobile according to an embodiment of the present invention will now be described with reference to the accompanying drawings. Note that the same reference numeral is used to denote the same component included in the conventional clip.

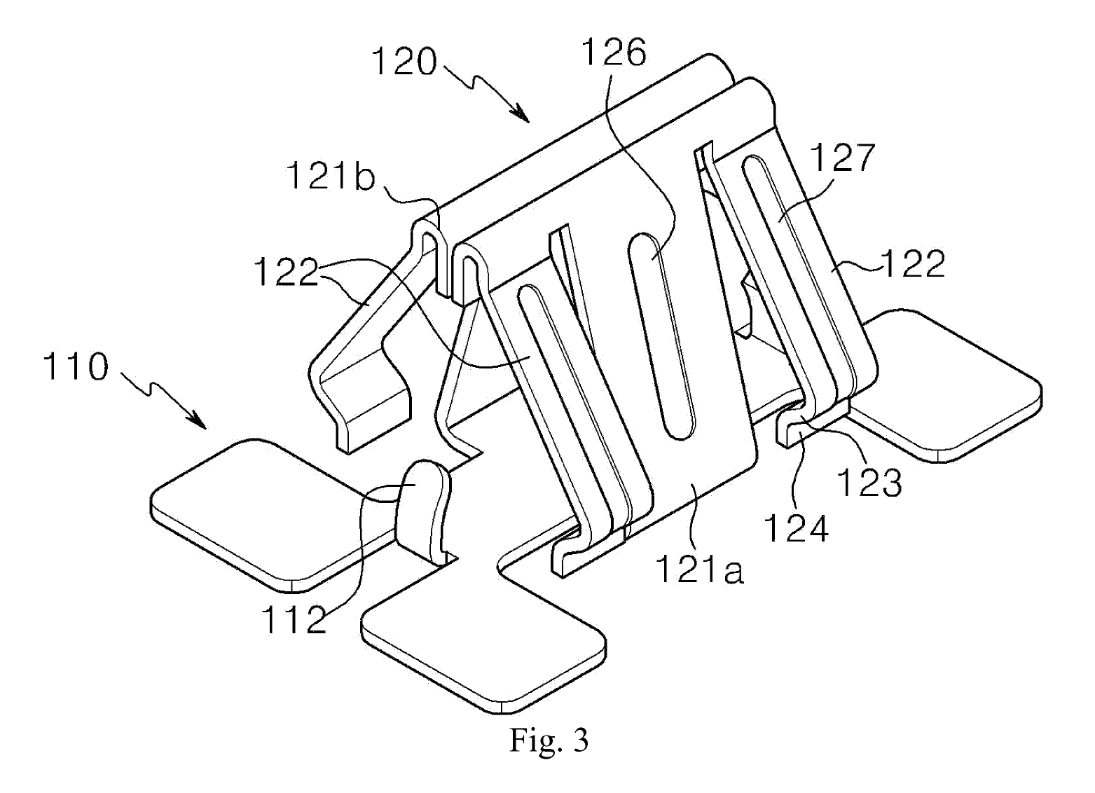

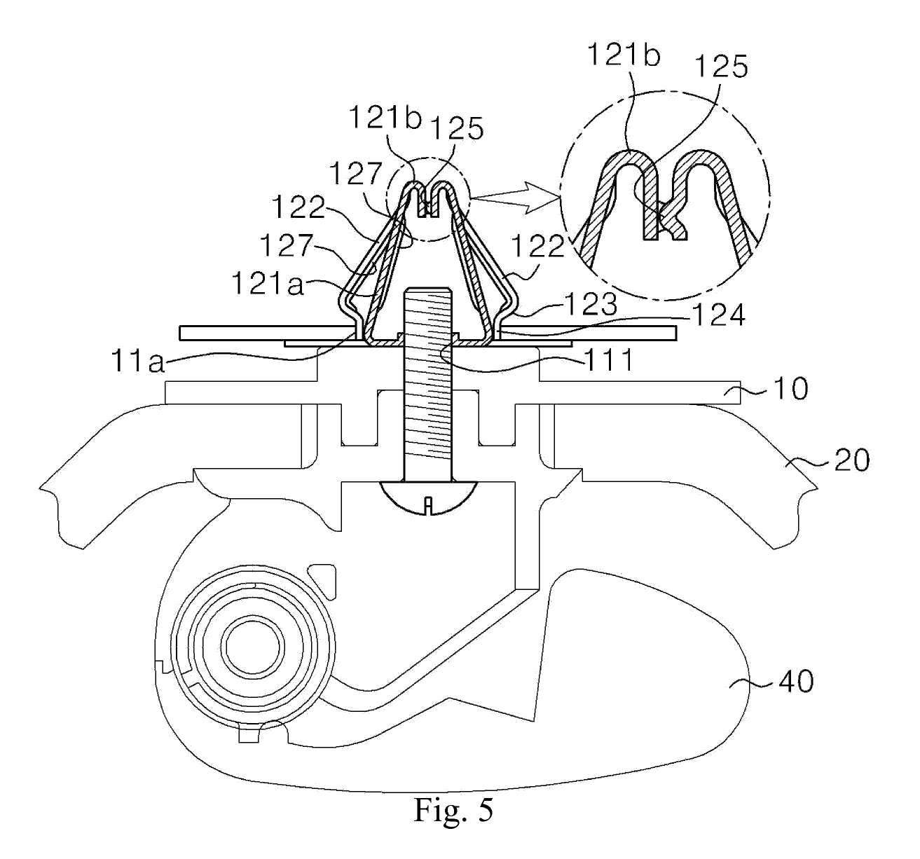

FIG. 3 is a perspective view showing the inventive clip, and FIG. 5 is a cross-sectional view showing an appearance in which the inventive clip is assembled to the head liner and body panel. Referring to FIGS. 3 and 5, the inventive clip includes a base 110 generally in the shape of a flat plate, and a hook 120 generally in the shape of a wedge.

The base 110 has the shape of the flat plate so as to extend in front and rear directions of the hook at a predetermined length. When the base 110 is assembled, the extending parts thereof are supported in contact with an inner side of a body panel of an automobile, and a middle part thereof is provided with a fastening hole 111 screwed with an assistant handle 40 as in FIG. 5.

Further, the base 110 is provided with a pair of guide flanges 112, each of which is cut in a C shape and is bent upward, so as to be located in front and rear of the hook. The guide flanges 112 are configured so that lower portions thereof are bent in the outward opposite directions, so that upper portions thereof are bent in the inward opposite directions, and so that upper portions thereof guide the inventive clip so as to be assembled into a coupling hole 11 of the body panel 10 at a designated position when assembled. Further, the lower portion of each guide flange 112 comes into close contact with a circumferential surface 11a of the coupling hole 11 of the body panel 10 so as to prevent the inventive clip from arbitrarily moving back and forth.

The hook 120 includes: support arms 121a bent at opposite sides of the base 110 in inward opposite directions so as to be inclined upward; flanges 121b, each of which extends toward opposite sides of an upper end of each support arm 121a and is bent downward; two pairs of retaining arms 122 bent at opposite sides of the flanges 121b in outward opposite directions so as to be inclined downward; retaining parts 123 bent at lower ends of the retaining arms 122 in the inward opposite directions so as to be inclined downward; retaining steps 124 bent downward at lower ends of the retaining parts 123 and hooked on the circumferential surface 11a of the coupling hole 11 of the body panel 10; and at least one noiseproof protrusion 125 protruding from opposite faces of the flanges 121b in the inward opposite directions so as to suppress noises caused by mutual contact between the flanges 121b.

Here, the support arms 121a are intended to firmly connect the hook 120 to the base 110. To this end, the support arms 121a are formed in the middle of the hook 120. Further, to improve strength of the support arms 121a, the support arms 121a may be further provided with beads 126 that extend in a vertical direction and protrude in the inward opposite directions.

The flanges 121b are intended to reinforce strength and rigidity of an upper end of the hook 120, and are configured to be bent at opposite upper ends of the support arms 121a to extend downward to a predetermined length. Here, the downwardly bent length may range from 3 mm to 6 mm.

When a passenger holds the assistant handle fixed to the body panel 10 of the automobile in the interior of the automobile that is traveling, force is applied downward. The opposite faces of the opposite flanges 121b are brought into contact by the applied force and accelerating and decelerating forces generated by the traveling of the automobile, and thus there is a risk of generating noise that is offensive to the ear. As a means for preventing this, at least one noise-proof protrusions 125 protrude from the opposite faces of the opposite flanges 121b in the inward opposite directions, and are in point contact between the flanges 121b, thereby suppressing the generation of noise.

The retaining arms 122, the retaining parts 123, and the retaining steps 124 are used to fix the inventive clip to the coupling hole 11 of the body panel 10. When the inventive clip is pushed with the hook 120 fitted into the coupling hole 11 of the body panel 10, the retaining arms 122 are deformed in the inward opposite directions, are inserted into the coupling hole 11 of the body panel 10, and then are elastically restored. Thus, the retaining steps 124 come into close contact with the circumferential surface 11a of the coupling hole 11 of the body panel 10. The retaining parts 123 come into close contact with an edge of the circumferential surface 11a of the coupling hole 11 of the body panel 10. Thereby, the inventive clip is firmly fixed to the coupling hole 11 of the body panel 10. Alternatively, the retaining arms 122 may be further provided with beads 127 that extend in a vertical direction and protrude in the inward opposite directions in order to improve strength.

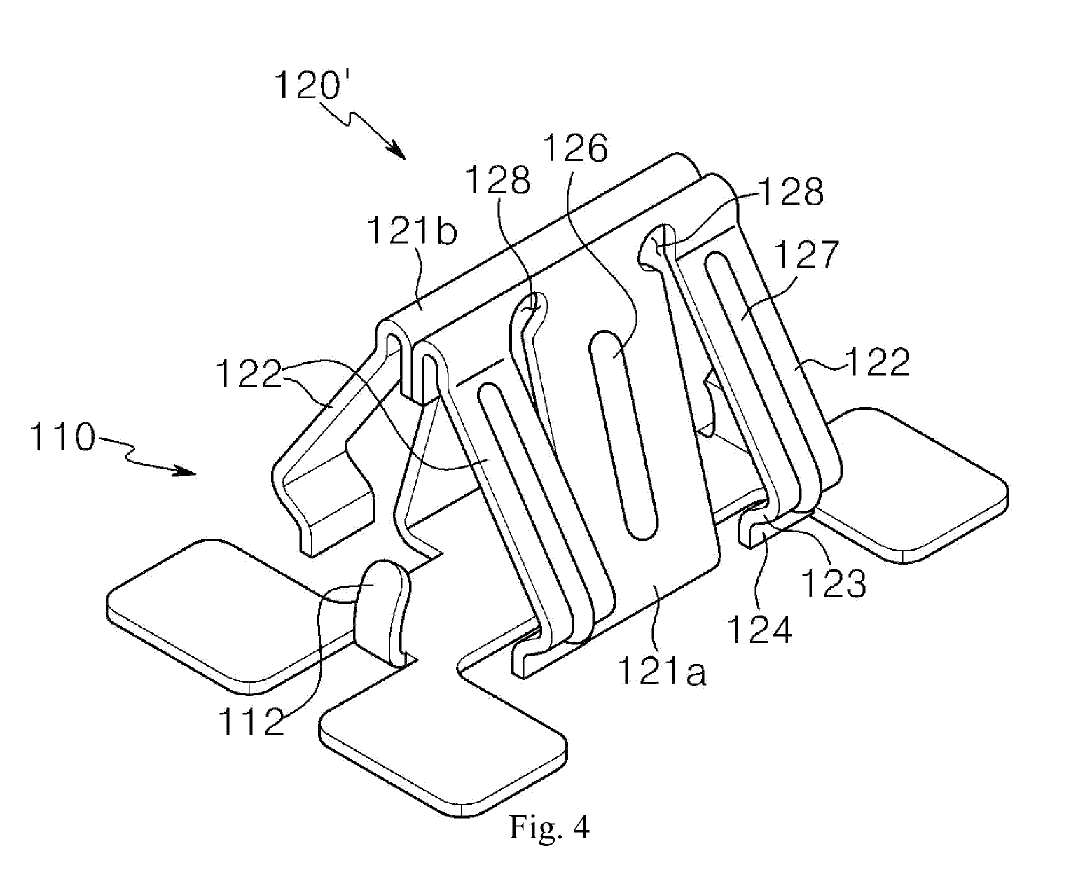

Meanwhile, FIG. 4 shows a modification of the clip according to the embodiment of the present invention. Here, the same reference numerals are used to denote the same components as the aforementioned embodiment, and so its detailed description will be omitted.

In the modification, a hook 120 is configured to increase a width of each connection region of the retaining arms 122. Thereby, when the retaining arms 122 are practically subjected to deformation, rigidity of the connection regions of the retaining arms 122 with the flanges 121b which undergo greatest moment can be reinforced.

To this end, a cutout part 128 is formed to additionally extend from each connection region of the retaining arms 122 with the support arms 121a. Here, the cutout part 128 is formed by extending from the connection region toward each support arm 121a in such a manner that a width of each connection region of the retaining arms 122 with the flanges 121b is wider than that of a region other than each connection region of the retaining arms 122.

For example, the cutout part 128 is formed by punching a circular hole. Here, the circular cutout part 128 is configured so that one side thereof is tangent to an upper end of each retaining arm 122 and so that a diameter thereof is greater than a width between each support arm 121a and each retaining arm 122. Thus, each connection region of the retaining arms 122 is increased in proportion to two quadrants removed from the circular cutout part 128.

Hereinafter, manufacturing costs of the conventional clip and the inventive clip will be compared.

First, comparing the manufacturing costs, as described in the “Background Art” section, the hook 33 of the conventional clip is configured so that each inner wall 34 and each outer wall 36 overlap in whole in the vertical direction in such a manner that the inner walls 34 are bent at the opposite sides of the base 31 in the inward opposite directions so as to be inclined upward, and then the outer walls 36 are bent at the upper ends of the inner walls 34 in the outward opposite directions so as to be inclined downward, i.e. that the inner walls 34 extend from the base 31 in the upward direction, and then the outer walls 36 extend from the upper ends of the inner walls 34 to the vicinity of the base 31 in the downward direction, and thus the conventional clip has a complicated structure. In contrast, the hook of the inventive clip is configured so that the support arms 121a extend upward from the base 110, so that the flanges 121b extend from the upper ends of the support arms 121a so as to be partly superposed on the support arms 121a in the vertical direction, and so that the retaining arms 122 extend from the flanges 121b, and thus the inventive clip has a simplified structure.

Thus, the conventional clip typically requires 18 to 25 processes to form a complicated structure, in which the inner walls 34 and the outer walls 36 overlap in whole in the vertical direction, using a sequential press process, whereas the inventive clip typically requires 9 to 12 processes due to the simplified structure. For this reason, the manufacturing cost of the inventive clip can be reduced corresponding to the number of reduced processes, compared to that of the conventional clip.

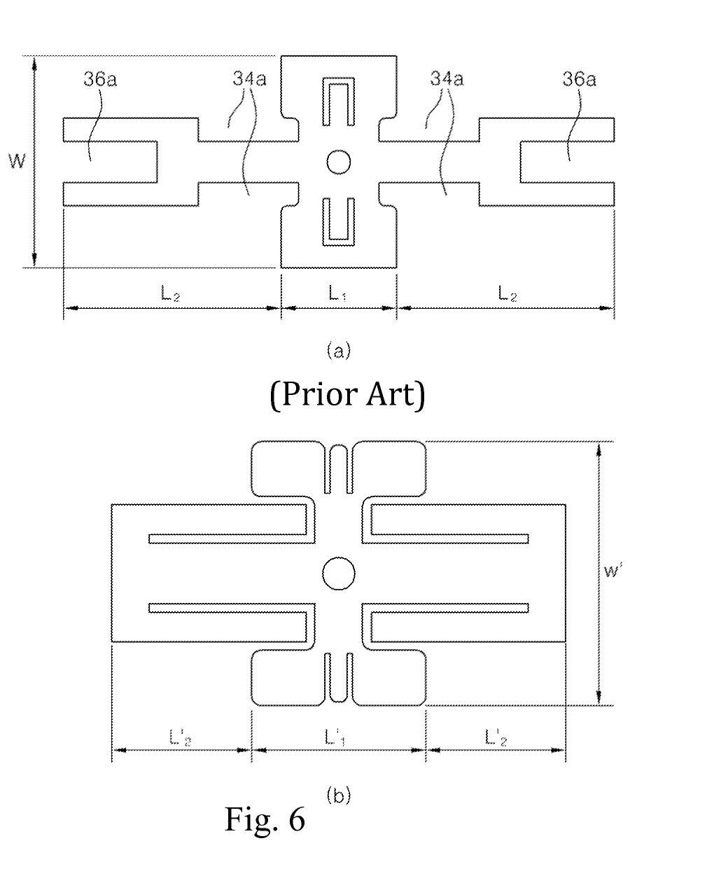

Further, FIGS. 6(a) and 6(b) are schematic development views showing the conventional clip and the inventive clip, respectively. Hereinafter, sizes of metal sheets required to manufacture the clips will be compared with reference to FIGS. 6(a) and 6(b). A width W of the required metal sheet of the conventional clip is equal to a width W′ of the required metal sheet of the inventive clip.

However, a length L of the required metal sheet of the conventional clip is longer than a length L′ of the required metal sheet of the inventive clip. In detail, the length L of the required metal sheet of the conventional clip is expressed by L=L₁+2L₂, and the length L′ of the required metal sheet of the inventive clip is expressed by L′=L′₁+2L′₂. Here, since L₁=L′₁ and L₂>L′₂, the length L of the required metal sheet of the conventional clip is longer than the length L′ of the required metal sheet of the inventive clip.

Accordingly, the size of the metal sheet required to manufacture the inventive clip is smaller than that of the metal sheet required to manufacture the conventional clip. As a result, in comparison with the manufacturing cost of the conventional clip, the manufacturing cost of the inventive clip can be reduced in proportion to the reduced size of the metal sheet.

1. An assistant handle clip for a module headliner of an automobile, comprising:
a base configured to be assembled between a body panel and the headliner of the automobile, and
a hook connected to the base, said hook integrally bent from the base at a leading end thereof and configured to be fitted into a coupling hole of the body panel,
wherein the hook comprises:
support arms having a first end and a second end, said first end of said support arms connected to the base in a way such that the support arms extend inwardly in an inclined upward direction from the base, wherein said support arms are bent at the first end at opposite sides of the base in inward directions towards a center of the assistant handle clip;
flanges connected to the second end of each support arm, said flanges configured to extend in a downward direction toward the base along inner surfaces of the support arms;
two retaining arms connected on opposite ends of each flange, each of said retaining arms configured to extend from the flange in outward directions away from the center of the assistant handle clip so as to be inclined downward toward the base;
retaining parts connected to lower ends of the retaining arms and bent in inward directions towards the center of the assistant handle clip so as to be inclined downward toward the base;
retaining steps connected to the retaining parts and bent downward at lower ends of the retaining parts towards the base and configured to be hooked on a circumferential surface of the coupling hole of the body panel; and
at least one noiseproof protrusion protruding from opposite faces of the flanges in inward directions towards the center of the assistant handle clip and configured to suppress noise caused by mutual contact between the flanges.

2. The assistant handle clip according to claim 1, wherein the support arms further include concave beads on an outer surface of the support arms that extend in a vertical direction, and the retaining arms further include concave beads on an outer surface of the retaining arms that extend in a vertical direction.

3. The assistant handle clip according to claim 1, wherein the base includes a pair of guide flanges, each of said guide flanges having a C shape and bent upwardly away from the base so as to be located along the center of the assistant handle clip in front of and behind the hook; the guide flanges being configured so that lower portions thereof are bent in the outward directions, so that upper portions thereof are bent in the inward direction, and so that upper portions thereof are configured to guide the clip so as to be assembled into the coupling hole of the body panel at a designated position when assembled; and the lower portion of each guide flange comes into close contact with the circumferential surface of the coupling hole of the body panel so as to prevent the assistant handle clip from moving back and forth.

4. The assistant handle clip according claim 1, wherein a cutout part is formed in each connection region of the retaining arms with the support arms, and extends toward each support arm in such a manner that a width of each connection region of the retaining arms with the flanges is widened.
